(19) United States
(12) Patent Application Publication
(10) Pub. No.: US 2009/0241871 A1
(43) Pub. Date: Oct. 1, 2009

(54) ASSEMBLED CAMSHAFT AND INTERNAL COMBUSTION ENGINE PROVIDED WITH ASSEMBLED CAMSHAFT

(75) Inventors: Yasushi Hibino, Nishikamo-gun (JP); Toshio Imamura, Okazaki-shi (JP); Shuji Morita, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/310,386

(22) PCT Filed: Aug. 16, 2007
(86) PCT No.: PCT/IB2007/002356

§ 371 Date: Feb. 24, 2009

(30) Foreign Application Priority Data
Aug. 28, 2006 (JP) 2006-230549

(51) Int. Cl. F01L 1/04; B23P 19/02

(52) U.S. Cl. 123/90.6; 29/525

(57) ABSTRACT

The degree of freedom in a mounting position of a fuel pump driving cam (115) is improved by making valve operating cams (130R) separate members from a camshaft main body (30R) and mounting the valve operating cams (130R) from the outside in the axial direction of the camshaft main body (30R) after mounting the fuel pump driving cam (115) onto the camshaft main body (30R). Also, the valve operating cams (130R) are formed of solid phase sintered material while the fuel pump driving cam (115) is formed of liquid phase sintered material.

### BACKGROUND OF THE INVENTION

1. Field of the Invention

The invention relates to a camshaft provided in an internal combustion engine represented by an automobile engine or the like. More particularly, the invention relates to an assembled camshaft formed of a plurality of parts that have been integrally assembled together, and an internal combustion engine provided with this assembled camshaft.

2. Description of the Related Art

Japanese Patent Application Publication No. JP-A-7-54096, for example, describes technology in which cams corresponding to intake valves and exhaust valves (hereinafter these cams will be referred to as “valve operating cams”) of an internal combustion engine (hereinafter simply referred to as “engine”) are provided on a camshaft (or camshafts) for opening and closing the intake and exhaust valves (In an OHC engine a single camshaft is shared between the intake system and the exhaust system. In a DOHC engine, a separate camshaft is arranged for each system, i.e., one camshaft is provided for the intake system and another camshaft is provided for the exhaust system). That is, the valve operating cams rotate together with the camshaft, and as these valve operating cams rotate, the cam noses of the valve operating cams apply pressure to the intake and exhaust valves, thus driving the valves open. Incidentally, with a typical cast iron camshaft, the camshaft main body and the valve operating cams are integrally formed.

Meanwhile, in an engine in which high pressure is required to supply fuel to fuel injectors, as is the case with an in-cylinder direct injection type engine, for example, fuel pumped up from a fuel tank is pressurized by a high pressure fuel pump and supplied toward the fuel injectors. More specifically, as described in Japanese Patent Application Publication No. JP-A-2005-133618, for example, a plunger pump is employed as a high pressure fuel pump. This high pressure fuel pump is operated using the rotational driving force of the camshaft. That is, a fuel pump driving cam is integrally assembled to the camshaft. Therefore, as the camshaft rotates so does the fuel pump driving cam, and as the fuel pump driving cam rotates, the cam nose of this fuel pump driving cam applies pressure to a lifter of the high pressure fuel pump, thus moving a plunger back and forth which increases the pressure of the fuel.

However, because the fuel pump driving cam applies pressure to the lifter of the high pressure fuel pump while sliding against it, the fuel pump driving cam must be highly resistant to scuffing and have high fatigue strength. In view of this, with the technology described in Japanese Patent Application Publication No. JP-A-2005-133618, the fuel pump driving cam is formed separate from the cam shaft main body and the fuel pump driving cam alone is made of sintered material, thus ensuring scuffing resistance and fatigue strength. In this case, an opening is formed in the center portion of the fuel pump driving cam and the fuel pump driving cam is press-fitted onto a fuel pump driving cam mounting portion provided on the camshaft main body.

However, when the fuel pump driving cam is integrally assembled to the camshaft main body, as in the case of the structure described in Japanese Patent Application Publication No. JP-A-2005-133618, the mounting position of the fuel pump driving cam must be to the outside, in the axial direction of the camshaft, of the positions where the valve operating cams are formed, i.e., the mounting position of the fuel pump driving cam must be on an end portion on one side of the camshaft main body, because the valve operating cams are integrally formed on the camshaft main body, as described above. For example, with a longitudinal mounted engine, the mounting position of the fuel pump driving cam is in the vicinity of the front end portion or the rear end portion of the engine. Because the high pressure fuel pump is arranged above the mounting position of the fuel pump driving cam, this high pressure fuel pump is therefore arranged protruding upward in the vicinity of the front end portion or the rear end portion of the engine.

If the high pressure fuel pump were arranged protruding upward in the vicinity of the front end portion of the engine, sufficient distance must be ensured between the upper end of the high pressure fuel pump and the bonnet (i.e., engine hood) which would interfere with the degree of freedom in design for obtaining a structure that would protect a pedestrian in the event of contact with a pedestrian. On the other hand, if the high pressure fuel pump were arranged protruding upward in the vicinity of the rear end portion of the engine, there is a possibility that the high pressure fuel pump would interfere with the dash panel (i.e., the panel that isolates the engine room from the cabin interior). To avoid this interference, the design of the dash panel or the high pressure fuel pump may have to be newly modified.

### SUMMARY OF THE INVENTION

This invention thus provides a structure that increases the degree of freedom in the mounting position of a fuel pump driving cam on an assembled camshaft formed with a fuel pump driving cam for driving a fuel pump assembled onto a camshaft main body.

The invention aims to increase the degree of freedom in the mounting position of a fuel pump driving cam by having valve operating cams be separate members from a camshaft main body, and mounting these valve operating cams onto the camshaft main body from the outside in the axial direction after first mounting the fuel pump driving cam onto the camshaft main body.

A first aspect of the invention thus relates to an assembled camshaft in which a fuel pump driving cam is assembled onto a camshaft main body that is provided with a plurality of valve operating cams. This assembled camshaft is characterised in that the fuel pump driving cam is assembled onto the camshaft main body by press-fitting in a position between the outer most valve operating cams in an axial direction of the camshaft main body, from among the plurality of valve operating cams that are arranged along the camshaft main body in the axial direction, and at least one of the outer most valve operating cams is assembled to the camshaft main body by press-fitting.

According to the foregoing assembled camshaft, first the fuel pump driving cam is assembled by press-fitting in a predetermined position in the axial direction of the camshaft main body, after which the valve operating cams are then assembled by press-fitting in predetermined positions to the outside of that fuel pump driving cam (i.e., to the outside in the axial direction of the camshaft main body). Accordingly, the fuel pump driving cam can be mounted in a substantially central position in the axial direction of the camshaft main body without interfering with the valve operating cams, and thus a fuel pump which is driven by the rotation of this fuel pump driving cam can also be arranged in a substantially central position in the axial direction. As a result, a large degree of freedom in design is able to be ensured for obtaining a structure that can protect a pedestrian in the event of contact with a pedestrian. Moreover, the fuel pump will not interfere with the dash panel.

In the foregoing aspect, a plurality of valve operating cam press-fitting portions and a single fuel pump driving cam press-fitting portion may be formed on the camshaft main body, and an outer diameter dimension of the fuel pump driving cam press-fitting portion may be larger than the outer diameter dimensions of the valve operating cam press-fitting portions.

According to this structure, openings that substantially match the outer diameter dimensions of the valve operating cam press-fitting portions are formed in the center portions of the valve operating cams and an opening that substantially matches the outer diameter dimension of the fuel pump driving cam press-fitting portion is formed in the center portion of the fuel pump driving cam. As described above, the outer diameter dimension of the fuel pump driving cam press-fitting portion is made larger than the outer diameter dimensions of the valve operating cam press-fitting portions so the inner diameter dimension of the opening in the fuel pump driving cam is larger than the outer diameter dimensions of the valve operating cam press-fitting portions. Therefore, when mounting the fuel pump driving cam, the fuel pump driving cam, which is fit over the camshaft main body from one end side, is able to pass smoothly over the valve operating cam press-fitting portions all the way up to the fuel pump driving cam press-fitting portion without the inside edge of the opening in the fuel pump driving cam interfering with valve operating cam press-fitting portions, thereby facilitating the work of assembling the fuel pump driving cam. Further, making the outer diameter dimension of the fuel pump driving cam press-fitting portion larger in this way makes it possible to ensure a large contact area between the outer peripheral surface of the fuel pump driving cam press-fitting portion and the inner peripheral surface of the opening formed in the fuel pump driving cam. As a result, the fuel pump driving cam can be securely fixed to the fuel pump driving cam press-fitting portion, thus increasing the retaining force of the fuel pump driving cam, making it less likely that the fuel pump driving cam will slip off.

In the foregoing aspect, the valve operating cams may be formed of solid phase sintered material. Also in the foregoing aspect, the fuel pump driving cam may be formed of liquid phase sintered material. Accordingly, the cam shapes (cam faces) of the valve operating cams can be precisely maintained and high resistance to scuffing and high fatigue strength of the fuel pump driving cam can be ensured.

A second aspect of the invention relates to an internal combustion engine provided with the assembled camshaft according to the first aspect. This internal combustion engine is characterised by including a cylinder head that rotatably supports the assembled camshaft; a fuel pump that increases a pressure of fuel supplied to a combustion chamber of the internal combustion engine; and a fuel pump support bracket which is supported by the cylinder head and supports the fuel pump above the fuel pump driving cam.

In the invention, the valve operating cams are formed by members that are separate from the camshaft main body so that the valve operating cams can be mounted from the outside in the axial direction of the camshaft main body after the fuel pump driving cam has been mounted to the camshaft main body. Accordingly, the degree of freedom in the mounting position of the fuel pump driving cam is able to be increased. As a result, the fuel pump, which is driven by the rotation of the fuel pump driving cam, can be arranged in substantially a central position in the axial direction of the camshaft main body, thus ensuring a greater degree of freedom in design for obtaining a structure that can protect a pedestrian in the event of contact with a pedestrian, and eliminating interference between the fuel pump and the dash panel.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic diagram of the inside of a V-type engine provided with an assembled camshaft according to one example embodiment of the invention as viewed from a direction along the axis of the crankshaft;

FIG. 2 is a system block diagram which schematically shows the engine together with intake and exhaust systems;

FIG. 3 is a view showing in frame format the structure of a fuel supply system;

FIG. 4 is a side view of an intake camshaft;

FIG. 5 is an exploded view of the intake camshaft; and

FIG. 6 is an exploded perspective view of a camshaft housing, camshafts, a pump support bracket, and cam caps.

### DETAILED DESCRIPTION OF THE EXAMPLE EMBODIMENTS

An assembled camshaft according to one example embodiment of the invention will now be described with reference to the accompanying drawings. In the following description, the assembled camshaft is mounted in a V-type eight cylinder engine (internal combustion engine) for an automobile.

Description of the Overall Structure of the Engine

Before describing the structure of the assembled camshaft according to this example embodiment of the invention, the overall structure of the engine in which the assembled camshaft is mounted will be described.

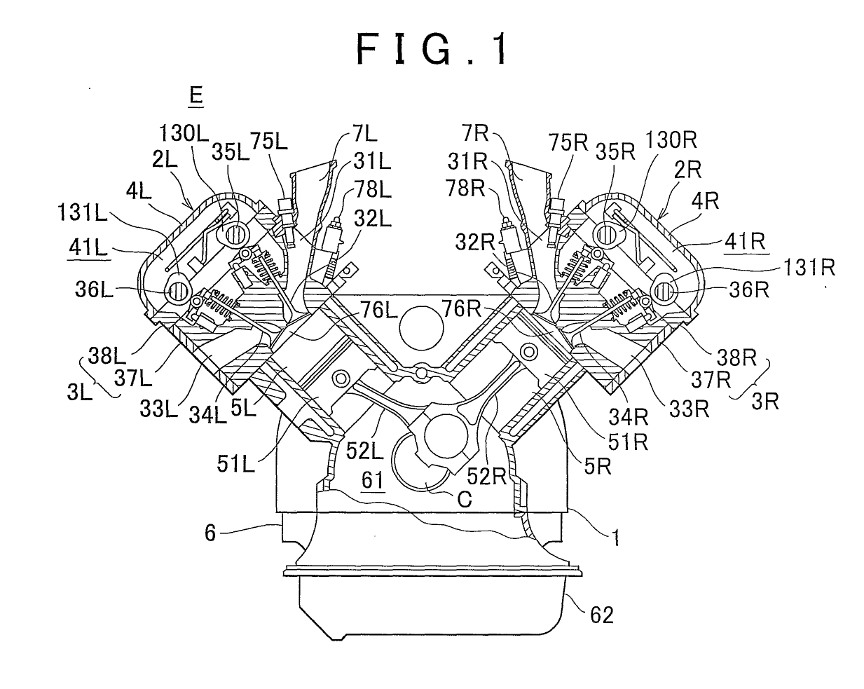

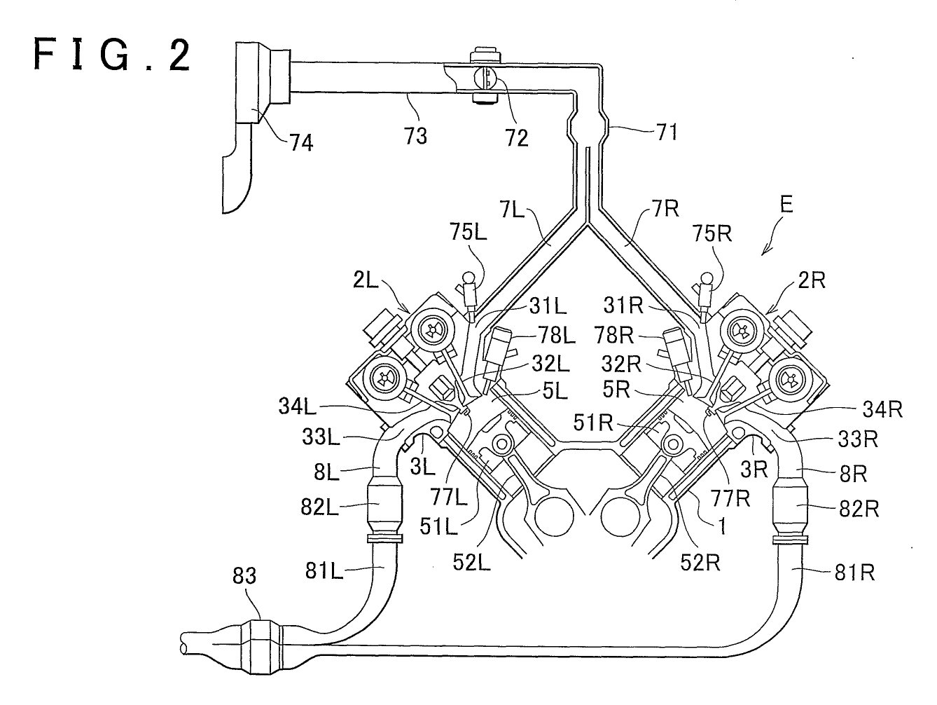

FIG. 1 is a schematic diagram of the inside of a V-type engine E provided with an assembled camshaft according to one example embodiment as viewed from a direction along the axis of a crankshaft C. Also, FIG. 2 is a system block diagram which schematically shows the engine E together with intake and exhaust systems.

Only one pair of cylinders 5L and 5R is shown in FIG. 1; the other cylinders are omitted. Therefore, in the following description, only the cylinders 5L and 5R shown in FIG. I will be described. As shown in the drawing, the V-type engine E has a pair of banks 2L and 2R protruding in a V shape on the upper portion of a cylinder block 1. Each bank 2L and 2R has a cylinder head 3L and 3R arranged on the upper end portion of the cylinder block 1, and a head cover 4L and 4R provided on the upper end of each cylinder head 3L and 3R. The plurality of cylinders 5L and 5R (e.g., four in each of the banks 2L and 2R) are arranged in the cylinder block 1 at predetermined included angle (such as 90°). Pistons 51L and 51R are housed inside these cylinders 5L and 5R in a manner that enables them to move up and down. Also, the pistons 51L and 51R are each connected to the crankshaft C via connecting rods 52L and 52R so that power can be transferred to the crankshaft C. Further, a crankcase 6 is mounted to the lower side of the cylinder block 1, and the space that extends from the lower portion inside the cylinder block 1 to inside of the crankcase 6 serves as the crank chamber 61. Also, an oil pan 62 which serves as an oil catching portion is arranged underneath the crankcase 6.

Also, intake valves 32L and 32R for opening and closing intake ports 31L and 31R, as well as exhaust valves 34L and 34R for opening and closing exhaust ports 33L and 33R are mounted to the cylinder heads 3L and 3R. These valves 32L, 32R, 34L, and 34R are operated open and closed by the rotation of camshafts 35L, 35R, 36L, and 36R arranged in cam chambers 41L and 41R formed between the cylinder heads 3L and 3R and the head covers 4L and 4R. That is, cam noses of valve operating cams 130L, 130R, 131L, and 131R provided on the camshafts 35L, 35R, 36L, and 36R apply pressure to the valves 32L, 32R, 34L, and 34R, thereby opening the valves 32L, 32R, 34L, and 34R. Incidentally, the valve operating system in this example embodiment is a roller rocker arm system.

Also, the cylinder heads 3L and 3R of the engine E provided with the assembled camshaft according to this example embodiment have split structures. More specifically, the cylinder heads 3L and 3R are each formed by a cylinder head main body 37L and 37R that is mounted to the upper surface of the cylinder block 1, and a camshaft housing 38L and 38R that is mounted to the upper side of this cylinder head main body 37L and 37R. The reason for this kind of split construction is because it makes it easier to assemble the component parts of the engine. That is, the intake valves 32L and 32R, the exhaust valves 34L and 34R, and the various parts of the valve operating mechanisms are assembled to the cylinder head main bodies 37L and 37R, while the camshafts 35L, 35R, 36L, and 36R are supported by the camshaft housings 38L and 38R. Then the camshaft housings 38L and 38R are integrally assembled to the upper sides of the cylinder head main bodies 37L and 37R by bolts or other such means, thus completing the cylinder heads 3L and 3R. Hence, workability when assembling the component parts of the engine is improved.

Meanwhile, intake manifolds 7L and 7R, which correspond to the banks 2L and 2R, respectively, are arranged on the upper portion on the insides (i.e., the sides between the banks) of the banks 2L and 2R. The downstream ends of the intake manifolds 7L and 7R are communicated with the intake ports 31L and 31R. The intake manifolds 7L and 7R are also communicated with an intake pipe 73 which is provided with a surge tank 71 (see FIG. 2) and a throttle valve 72 and is common to both banks. An air cleaner 74 is provided on the upstream side of this intake pipe 73. Accordingly, air introduced from the air cleaner 74 into the intake pipe 73 is introduced into the intake manifolds 7L and 7R through the surge tank 71.

Port injection fuel injectors (i.e., port injection fuel injection valves) 75L and 75R are provided in the intake ports 31L and 31R of the cylinder heads 3L and 3R. When fuel is injected from these port injection fuel injectors 75L and 75R, it mixes with the air introduced into the intake manifolds 7L and 7R to form an air-fuel mixture which is then introduced into combustion chambers 76L and 76R as the intake valves 32L and 32R open.

Further, the engine E provided with the assembled camshaft according to this example embodiment is also provided with in-cylinder direct injection fuel injectors (in-cylinder direct injection fuel injection valves) 78L and 78R. When fuel is injected from these in-cylinder direct injection fuel injectors 78L and 78R, it is injected directly into the combustion chambers 76L and 76R.

One example of a fuel injection mode of the port injection fuel injectors 75L and 75R and the in-cylinder direct injection fuel injectors 78L and 78R is as follows. When the engine E is operating at a low to medium load, fuel is injected from both types of fuel injectors 75L, 75R, 78L, and 78R to form a homogeneous air-fuel mixture in attempt to improve fuel efficiency and reduce emissions. Also, when the engine E is operating at a high load, fuel is injected from only the in-cylinder direct injection fuel injectors 78L and 78R in attempt to suppress knocking and improve charging efficiency from the intake air cooling effect. The fuel injection mode of these fuel injectors 75L, 75R, 78L, and 78R is not limited to this, however.

The fuel supply system for supplying fuel to these port injection fuel injectors 75L and 75R and in-cylinder direct injection fuel injectors 78L and 78R will be described later.

As shown in FIG. 2, spark plugs 77L and 77R are arranged at the top of the combustion chambers 76L and 76R. In the combustion chambers 76L and 76R, the firing pressure of the air-fuel mixture following firing of the spark plugs 77L and 77R is transmitted to the pistons 51L and 51R, causing them to move up and down. This reciprocal motion of the pistons 51L and 5iR is transmitted via connecting rods 52L and 52R to the crankshaft C where it is converted into rotary motion and extracted as output of the engine E. Also, the camshafts 35L, 35R, 36L, and 36R shown in FIG. 1 are rotatably driven by power derived from the crankshaft C that is transmitted by a timing chain. This rotation causes the valves 32L, 32R, 34L, and 34R to open and close.

The air-fuel mixture after combustion becomes exhaust gas which is discharged to exhaust manifolds 8L and 8R as the exhaust valves 34L and 34R shown in FIG. 2 open. Exhaust pipes 81L and 81R are connected to the exhaust manifolds 8L and 8R. In addition, catalytic converters 82L and 82R which house three way catalysts and the like are mounted to the exhaust pipes 81L and 81R. When the exhaust gas passes through these catalytic converters 82L and 82R, hydrocarbons (HC), carbon monoxide (CO), and nitrogen oxide components (NO_{X}) contained in the exhaust gas are removed. Also, the downstream ends of the exhaust pipes 81L and 81R merge together and connect to a muffler 83.

Fuel Supply System

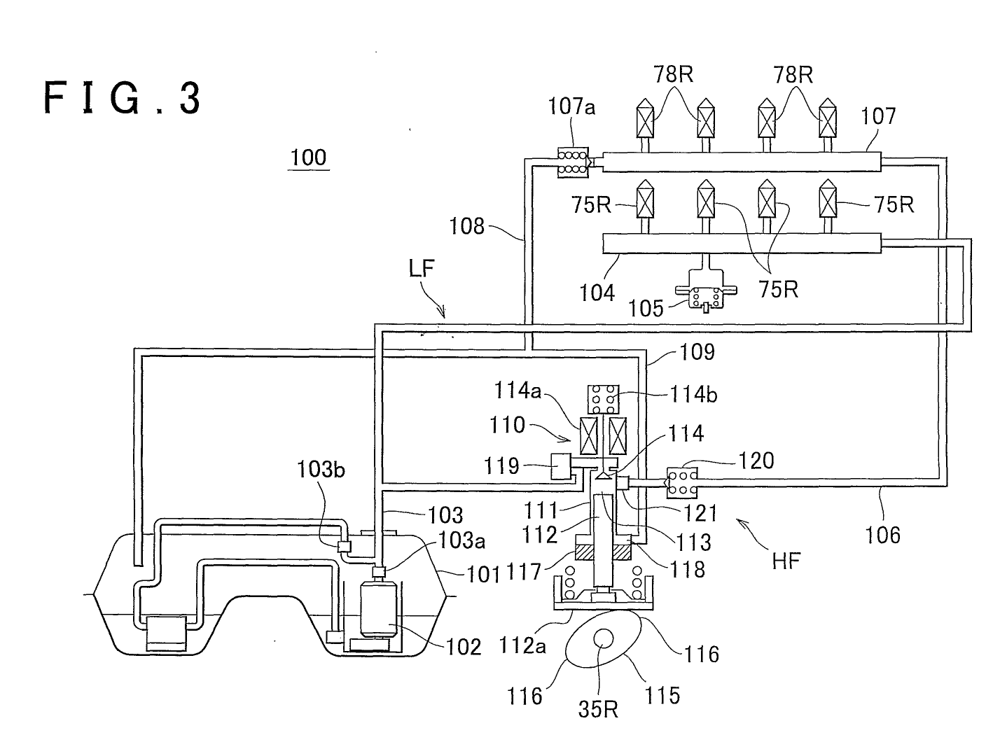

Next, a fuel supply system for supplying fuel to the port injection fuel injectors 75L and 75R and the in-cylinder direct injection fuel injectors 78L and 78R will be described with reference to FIG. 3. FIG. 3 is a view showing in frame format the structure of a fuel supply system 100 provided for one bank of the engine E provided with the assembled camshaft according to this example embodiment. That is, the engine E has two of these fuel supply systems 100, one provided for each bank 2L and 2R. Here, the fuel supply system 100 provided for the right bank 2R will be representatively described.

The fuel supply system 100 includes a feed pump 102 that pumps up fuel from a fuel tank 101. A low pressure fuel line 103 which is connected to the discharge side of this feed pump 102 branches off to a low pressure fuel line LF and a high pressure fuel line HF.

A low pressure fuel line delivery pipe 104 that is connected to one branch side of the low pressure fuel line 103 is provided in the low pressure fuel line LF. This low pressure fuel line delivery pipe 104 is connected to the port injection fuel injector 57R of each cylinder (i.e., each of the four cylinders), and is provided with a pulsation damper 105 for suppressing fuel pressure pulsations in the low pressure fuel line delivery pipe 104.

Meanwhile, the high pressure fuel line HF is provided with a high pressure fuel pump 110 that pressurizes fuel pumped up by the feed pump 102 and drawn in via the other branch side of the low pressure fuel line 103, and then discharges that pressurized fuel toward the in-cylinder direct injection fuel injector 78R of each cylinder (i.e., each of the four cylinders).

The general structure of this high pressure fuel pump 110 includes a cylinder 111, a plunger 112, a pressurizing chamber 113, and an electromagnetic spill valve 114. A lifter 112a is mounted to the lower end of the plunger 112, and a fuel pump driving cam 115 is mounted to the intake camshaft 35R. This fuel pump driving cam 115 has two cam lobes (cam noses) 116 formed at angles 180° apart from one another around the rotational axis of the intake camshaft 35R. As a result, when the fuel pump driving cam 115 rotates with the intake camshaft 35R, the cam noses 116 push the plunger 112 up via the lifter 112a such that the plunger 112 moves up and down inside the cylinder 111, and as it does so, the volume of the pressurizing chamber 113 increases and decreases.

Incidentally, each bank of the engine E provided with the assembled camshaft according to this example embodiment has four cylinders. Therefore, during one cycle of the engine E, i.e., for every two revolutions of the crankshaft C, fuel injection is performed once by each fuel injector(s) (either one or both of the port injection fuel injector 75R and the in-cylinder direct injection fuel injector 78R) provided for each cylinder. Also, in this engine E, the intake camshaft 35R rotates once for every two revolutions of the crankshaft C. Accordingly, during one cycle of the engine E, there are four fuel injections from the fuel injectors 75R and 78R and pressurized fuel is discharged twice from the high pressure fuel pump 110.

The pressurizing chamber 113 is defined by the plunger 112 and the cylinder 111. This pressurizing chamber 113 is communicated with the feed pump 102 via the low pressure fuel line 103, as well as with a high pressure fuel line delivery pipe (i.e., accumulator) 107 via a high pressure line 106.

As shown in FIG. 3, the plurality of in-cylinder direct injection fuel injectors 78R are connected to the high pressure fuel line delivery pipe 107. A return line 108 is also connected to the high pressure fuel line delivery pipe 107 via a relief valve 107a. This relief valve 107a opens when the fuel pressure inside the high pressure fuel line delivery pipe 107 exceeds a predetermined pressure (such as 15 MPa). When the relief valve 107a opens, some of the fuel stored in the high pressure fuel line delivery pipe 107 returns to the fuel tank 101 via the return line 108, thus preventing the fuel pressure in the high pressure fuel line delivery pipe 107 from rising too high. Also, the return line 108 and the high pressure fuel pump 110 are connected together by a fuel discharge line 109. Fuel that leaks out from the gap between the plunger 112 and the cylinder 111 collects in a fuel collection chamber 118 above a seal unit 117 and is returned to the fuel tank 101 via the fuel discharge line 109, which is connected to the fuel collection chamber 118, and the return line 108.

A filter 103a and a pressure regulator 103b are provided in the low pressure fuel line 103. The pressure regulator 103b keeps the fuel pressure inside the low pressure fuel line 103 equal to or less than a predetermined pressure by returning fuel in the low pressure fuel line 103 to the fuel tank 101 when the fuel pressure in the low pressure fuel line 103 exceeds a predetermined pressure (such as 0.4 MPa). Also, a pulsation damper 119 is provided on the intake side of the high pressure fuel pump 110. This pulsation damper 119 suppresses fuel pressure pulsations in the low pressure fuel line 103 when the high pressure fuel pump 110 is operating. Also, a non-return valve 120 for preventing the backflow of fuel discharged from the high pressure fuel pump 110 is provided in the high pressure fuel line 106.

The electromagnetic spill valve 114 for allowing or preventing communication between the low pressure fuel line 103 and the pressurizing chamber 113 is provided in the high pressure fuel pump 110. This electromagnetic spill valve 114 has an electromagnetic solenoid 114a and is opened and closed by controlling the current flow to this electromagnetic solenoid 114a. The electromagnetic spill valve 114 opens by urging force from a coil spring 114b when current has stopped flowing to the electromagnetic solenoid 114a. Hereinafter, the opening and closing operation of this electromagnetic solenoid valve 114 will be described.

First when current has stopped flowing to the electromagnetic solenoid 114a, the electromagnetic spill valve 114 opens by the urging force from the coil spring 114b, thereby opening communication between the low pressure fuel line 103 and the pressurizing chamber 113. In this state, fuel pumped up by the feed pump 102 is drawn into the pressurizing chamber 113 via the low pressure fuel line 103 when the plunger 112 moves in the direction which increases the volume of the pressurizing- chamber 113 (i.e., during the intake stroke).

On the other hand, when the electromagnetic spill valve 114 closes, against the urging force of the coil spring 114b, by current flowing to the electromagnetic solenoid 114a when the plunger 112 moves in the direction that reduces the volume of the pressurizing chamber 113 (i.e., during the pressurizing stroke), communication between the low pressure fuel line 103 and the pressurizing chamber 113 is cut off. When the fuel pressure in the pressurizing chamber 113 reaches a predetermined value, a check valve 121 opens so that the high pressure fuel is discharged through the high pressure fuel line 106 toward the high pressure line delivery pipe 107.

The amount of fuel discharged from the high pressure fuel pump 110 (hereinafter also referred to as the “fuel discharge amount”) is adjusted by controlling the period of time for which the electromagnetic spill valve 114 is closed during the pressurizing stroke. That is, the fuel discharge amount increases when the electromagnetic spill valve 114 is kept closed for a longer period of time which is accomplished by having the valve start to close earlier. Conversely, the fuel discharge amount decreases when the electromagnetic spill valve 114 is kept closed for a shorter period of time which is accomplished by having the valve start to close later. In this way, the fuel pressure within the high pressure fuel line delivery pipe 107 can be controlled by adjusting the fuel discharge amount of the high pressure fuel pump 110.

The structure of the fuel supply system 100 provided for the right bank 2R shown in FIG. 1 is described above. The same fuel supply system 100 is also provided for the left bank 2L.

Structure of the Assembled Camshaft

Next, the structure of the intake camshafts (i.e., the assembled camshafts) 35L and 35R which are the characteristic members of this example embodiment will be described. The structure of the intake camshafts 35L and 35R provided for the banks 2L and 2R are the same so only the intake camshaft 35R provided for the right bank 2R will be representatively described here.

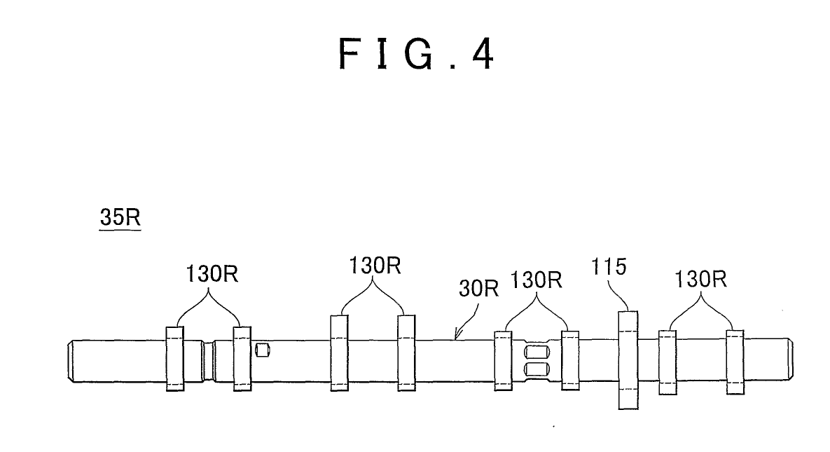

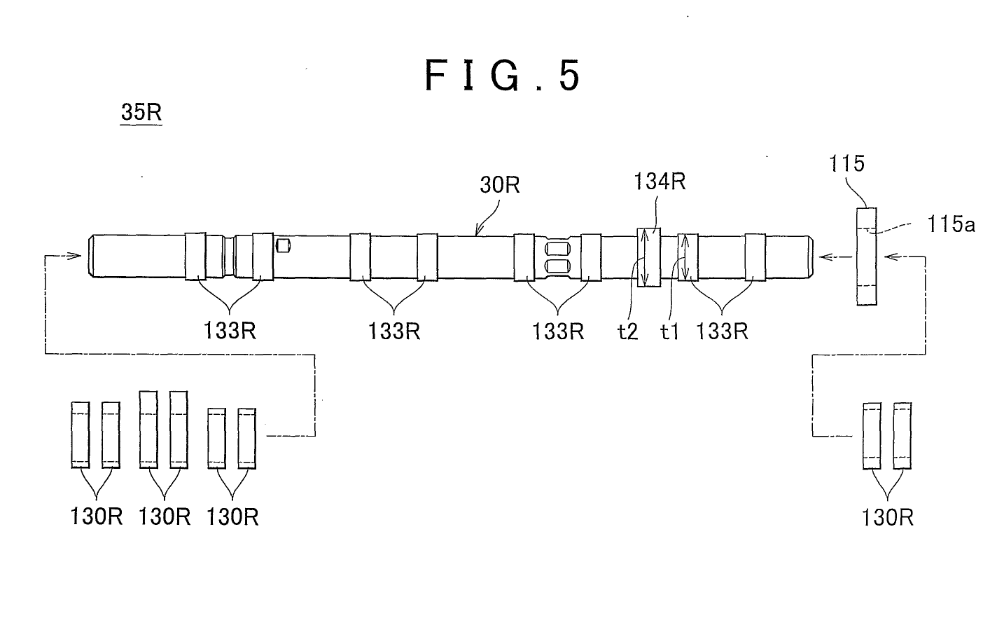

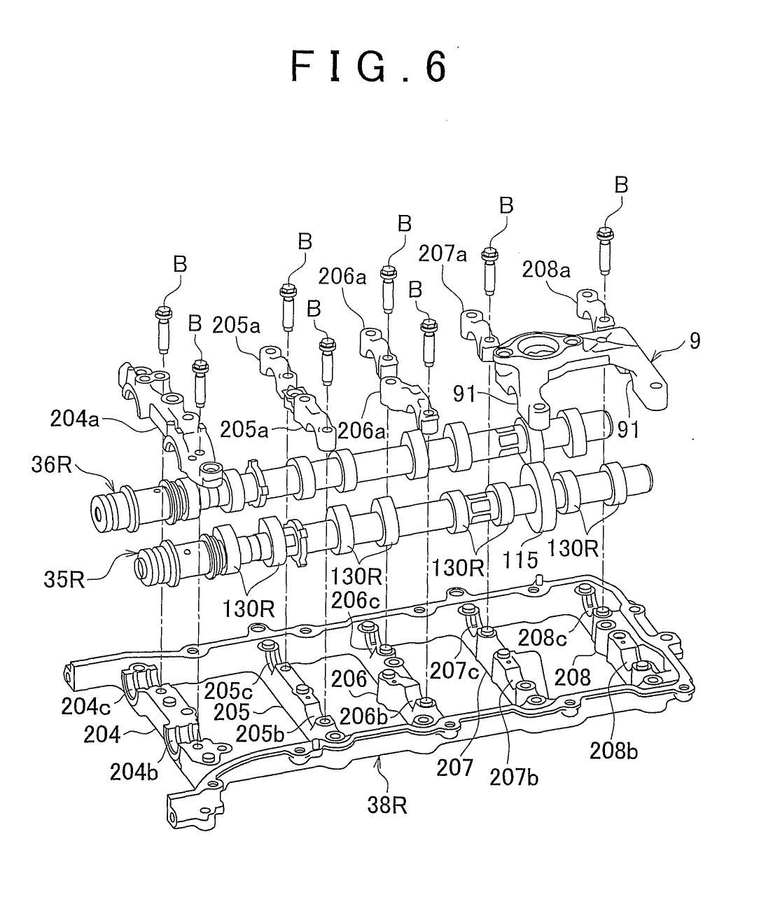

FIG. 4 is a side view of the intake camshaft 35R and FIG. 5 is an exploded view of the intake camshaft 35R. FIGS. 4 and 5 show only a camshaft main body 30R, which will be described later, the plurality of valve operating cams 130R, and the fuel pump driving cam 115 in order to facilitate understanding of the characteristics of the intake camshaft 35R. In actuality, the intake camshaft (i.e., assembled camshaft) 35R also has members other than the cams 130R and 115 assembled to it, such as a top journal member fitted to the end portion of the camshaft main body 30R. Also, FIG. 6 is an exploded perspective view (the left side in FIG. 6 is the front side of the engine) of the camshaft housing 38R, the camshafts 35R and 36R, and cam caps 204a to 208a.

As shown in FIG. 4, the intake camshaft 35R includes the camshaft main body 30R, eight valve operating cams 130R and the fuel pump driving cam 115 which are members that are formed separately from the camshaft main body 30R and then integrally assembled thereto.

The camshaft main body 30R is rotatably mounted on the camshaft housing 38R. As described above, the rotational force of the crankshaft C is transmitted to the camshaft main body 30R via a timing chain, not shown, thereby rotating the camshaft main body 30R. As shown in FIG. 5, valve operating cam press-fitting portions 130R for mounting the valve operating cams 133R are formed in a plurality of positions in the axial direction on the camshaft main body 30R. In addition, a fuel pump driving cam press-fitting portion 134R for mounting the fuel pump driving cam 115 is also formed on the camshaft main body 30R. The shapes of these press-fitting portions 133R and 134R are generally round when viewed from the direction along the axial center of the camshaft main body 30R, and the width dimensions (i.e., thickness dimensions) in the direction along the axial center of the camshaft main body 30R are substantially the same.

The valve operating cam press-fitting portions 133R are formed in positions corresponding to the positions of the intake valves 32R. The engine E in this example embodiment has two intake valves 32R for each cylinder and four cylinders in each bank 2R. Therefore, the valve operating cam press-fitting portions 133R are formed in eight locations in order to mount the eight valve operating cams 130R.

Meanwhile, the fuel pump driving cam press-fitting portion 134R is formed in a position to the inside, in the axial direction of the camshaft main body 30R, of the outer most valve operating cam press-fitting portions 133R in the axial direction of the camshaft main body 30R, from among the plurality of valve operating cam press-fitting portions 133R. More specifically, the fuel pump driving cam press-fitting portion 134R is formed between the set of two valve operating cam press-fitting portions 133R on the right side in FIG. 5 and the set of six valve operating cam press-fitting portions 133R on the left side in FIG. 5. As described above, the right bank 2R has four cylinders. When sets of two of the valve operating cam press-fitting portions 133R correspond to the #1, #2, #3, and #4 cylinders in that order from the left side in FIGS. 5 and 6, the fuel pump driving cam press-fitting portion 134R is formed in the region between the valve operating cam press-fitting portions 133R corresponding to the #3 cylinder and the valve operating cam press-fitting portions 133R corresponding to the #4 cylinder.

Also, while the outer diameter dimensions (dimension t1 in FIG. 5) of the valve operating cam press-fitting portions 133R are all substantially the same, the outer diameter dimension (dimension t2 in FIG. 5) of the fuel pump driving cam press-fitting portion 134R is slightly larger than the outer diameter dimensions of the valve operating cam press-fitting portions 133R. For example, the outer diameter dimension of the fuel pump driving cam press-fitting portion 134R is approximately 10 mm larger than the outer diameter dimensions of the valve operating cam press-fitting portion 133R.

The outer diameter dimensions of the valve operating cam press-fitting portions 133R do not necessarily have to be all the same. Alternatively, the outer diameter dimensions of the valve operating cam press-fitting portions 133R may be set such that the closer the valve operating cam press-fitting portion 133R is to the fuel pump driving cam press-fitting portion 134R, the larger the outer diameter dimension of that valve operating cam press-fitting portion 133R is. This facilitates the work of press-fitting the valve operating cams 130R onto the camshaft main body 30R, which will be described later. That is, the opening for press-fitting formed in a first valve operating cam 130R is larger than the outer diameter dimension of a valve operating cam press-fitting portion 133R to which a second valve operating cam 130R that is provided to the outside of the first valve operating cam 130R in the axial direction of the camshaft main body 30R is mounted. Therefore, the first valve operating cam 130R can fit smoothly over the valve operating cam press-fitting portion 133R to which the second valve operating cam 130R is to be mounted without the inside edge of the opening of the first valve operating cam 130R interfering with that valve operating cam press-fitting portion 133R.

Also, as shown in FIG. 4, the valve operating cams 130R are mounted onto the valve operating cam press-fitting portions 133R shown in FIG. 5 by press-fitting, and the fuel pump driving cam 115 is mounted onto the fuel pump driving cam press-fitting portion also by press-fitting.

The work of press-fitting these cams 130R and 115 involves first fitting the fuel pump driving cam 115 over the camshaft main body 30R from the right in the drawing in the axial direction of the camshaft main body 30R, as shown by the alternate long and short dash arrow in FIG. 5. At this time, the outer diameter dimension of the fuel pump driving cam press-fitting portion 134R is larger than the outer diameter dimensions of the valve operating cam press-fitting portions 133R, as described above, so the inner diameter dimension of the opening 115a for press-fitting that is formed in the fuel pump driving cam 115 is also larger than the outer diameter dimensions of the valve operating cam press-fitting portions 133R. Therefore, the fuel pump driving cam 115 can fit smoothly over the valve operating cam press-fitting portions 133R without the inside edge of the opening of the fuel pump driving cam 115 interfering with the valve operating cam press-fitting portions 133R. Once the fuel pump driving cam 115 has reached the fuel pump driving cam press-fitting portion 134R, it is then assembled to it by press-fitting.

Of course, if clamping force sufficient to prevent the fuel pump driving cam 115 from slipping off or rotating can be obtained and press-fitting assemblability, including that of the valve operating cams 130R, is not impeded, the outer diameters of the valve operating cam press-fitting portions 133R and the outer diameter of the fuel pump driving cam press-fitting portion 134R may also be the same.

Then, as shown by the alternate long and short dash arrow in FIG. 5, the valve operating cams 130R are fitted over the camshaft main body 30R in the axial direction of the camshaft main body 30R from both outside ends thereof (i.e., both outside ends in the axial direction of the camshaft main body 30R). When the valve operating cams 130R have reached their corresponding valve operating cam press-fitting portions 133R, they are assembled thereto by press-fitting.

The work of press-fitting the valve operating cams (the valve operating cams corresponding to the #1; #2, and #3 cylinders) 130R to the left of the position where the fuel pump driving cam 115 is mounted in the drawing may also be performed before press-fitting the fuel pump driving cam 115.

Press-fitting fuel pump driving cam 115 and the valve operating cams 130R may be done using a hot press-fitting method in which the press-fitting work is performed after the cams 115 and 130R have been heated (i.e., while they are hot). Alternately, splines or knurls may be formed beforehand on the outer peripheral surface of the press-fitting portions 133R and 134R and the cams 115 and 130R press-fit onto these press-fitting portions 133R and 134R.

As a result, the fuel pump driving cam 115 is mounted to the inside, in the axial direction of the camshaft main body 30R, of the outer most valve operating cams 130R in the axial direction of the camshaft main body 30R, from among the plurality of valve operating cams 130R, without interfering with the valve operating cams 130R. More specifically, the fuel pump driving cam 115 is mounted in a position between the set of two valve operating cams (the valve operating cams corresponding to the #4 cylinder) 130R on the right side in FIG. 4 and the set of six valve operating cams (the valve operating cams corresponding to the #1, #2, and #3 cylinders) 130R on the left side in FIG. 4.

The constituent material of the camshaft main body 30R according to this example embodiment is steel, the constituent material of the valve operating cams 130R according to this example embodiment is solid phase sintered material, and constituent material of the fuel pump driving cam 115 according to this example embodiment is liquid phase sintered material.

Forming the valve operating cams 130R of solid phase sintered material enables the cam shape (i.e., the shape of the cam face) when grinding the cam which is usually performed to be precisely maintained such that the opening and closing timing and the lift amounts of the intake valves 32R can be accurately set as desired. Also, forming the fuel pump driving cam 115 of liquid phase sintered material enables the fuel pump driving cam 115 to be formed with material having high bond strength between powders with extreme precision, thus making it possible to ensure high scuffing resistance and high fatigue strength.

The intake camshaft 35R, which was assembled as described above, and the exhaust camshaft 36R are both rotatably supported on the camshaft housing 38R by being placed on the camshaft housing 38R and then pinned down from above by the cam caps 204a to 208a, as shown in FIG. 6.

As shown in FIG. 6, bearing portions 204 to 208 for supporting the camshafts 35R and 36R are formed on the camshaft housing 38R. Bearing recessed portions 204b to 208b and 204c to 208c which are semi-circular arc shaped recessed portions for rotatably supporting the lower sides of the camshafts 35R and 36R are formed at the bearing portions 204 to 208. The cam caps 204a to 208a are fastened by bolts B to these bearing portions 204 to 208. The portions of the camshafts 35R and 36R that are supported by these bearing portions 204 to 208 are surface treated, e.g., induction hardened, to obtain high hardness.

Also, the member denoted by reference numeral 9 in FIG. 6 is a pump support bracket which is a member that supports the high pressure fuel pump 110. The high pressure fuel pump 110 is mounted in a position opposing the fuel pump driving cam 115 on the top face of this pump support bracket 9. Also, bearing recessed portions 91 which are semi-circular arc shaped recessed portions for rotatably supporting the upper side of the intake camshaft 35R are formed at portions corresponding to the bearing portions 207 and 208 on the bottom face the pump support bracket 9. That is, while the pump support bracket 9 is mounted on the camshaft housing 38R, the pump support bracket 9 rotatably supports the upper side of the intake camshaft 35R and thus effectively serves as a cam cap.

The structure of the intake camshaft 35R provided for the right bank 2R and the support structures of the camshafts 35R and 36R are described above. The same intake camshaft 35R is also provided for the left bank 2L.

As described above, in this example embodiment, the valve operating cams 130R are formed as separate members from the camshaft main body 30R so that they can be mounted onto the camshaft main body 30R from the outside in the axial direction of the camshaft main body 30R after the fuel pump driving cam 115 has been mounted onto the camshaft main body 30R. This improves the degree of freedom in the mounting position of the fuel pump driving cam 115. As a result, the high pressure fuel pump 110 which is driven by the rotation of the fuel pump driving cam 115 can be mounted in a central position on the camshaft main body 30R in the axial direction thereof. Further, a large degree of freedom in design can be ensured for obtaining a structure that will protect pedestrians in the event of contact with a pedestrian. In addition, the high pressure fuel pump 110 will not interfere with the dash panel.

Other Example Embodiments

In the example embodiment described above, the assembled camshaft according to the invention is applied to a V-type eight cylinder engine for an automobile. The invention is not limited to this, however. That is, the invention can also be applied to an inline-type engine for an automobile, or the like. Also, the invention is not limited to being applied to an engine for an automobile, but can also be applied to another engine. Further, the included angle of the V bank in the V-type engine E, as well as other specifications of the engine E, are not particularly limited.

Also in the foregoing example embodiment, in FIG. 4 the fuel pump driving cam 115 is mounted in a position with two valve operating cams 130R arranged to the right of the fuel pump driving cam 115 and six valve operating cam press-fitting portions 133R arranged to the left of the fuel pump driving cam 115. That is, the fuel pump driving cam 115 is mounted slightly more toward the rear of the engine than the center of the intake camshaft 35R in the axial direction. The invention is not limited to this, however. For example, the fuel pump driving cam 115 may be mounted in the center of the intake camshaft 35R in the axial direction (i.e., in FIG. 4, the fuel pump driving cam 115 may be mounted in a position with four valve operating cams 130R arranged to the right of the fuel pump driving cam 115 and four valve operating cams 130R arranged to the left of the fuel pump driving cam 115), or the fuel pump driving cam 115 may be mounted slightly more toward the front of the engine than the center of the intake camshaft 35R in the axial direction (i.e., in FIG. 4, the fuel pump driving cam, 115 may be mounted in a position in which there are six valve operating cams 130R arranged to the right of the fuel pump driving cam 115 and two valve operating cams 130R arranged to the left of the fuel pump driving cam 115).

Also, in the foregoing example embodiment, all of the valve operating cams 130R are formed as separate members from the camshaft main body 30R. The invention is not limited to this, however. That is, when mounting the fuel pump driving cam 115 onto the camshaft main body 30R, only the valve operating cams 130R that are arranged on the side from which the fuel pump driving cam 115 is fitted (i.e., to the right of the mounting position of the fuel pump driving cam 115 in the foregoing example embodiment) may be formed as separate members from the camshaft main body 30R. In this case, the valve operating cams 130R arranged on the side opposite the side from which the fuel pump driving cam 115 is fitted are formed integrally with, and of the same material as, the camshaft main body 30R so the surface treatment of the cam face and the like may be performed as necessary.

Furthermore, in the foregoing example embodiment, the invention is applied to the intake camshaft 35R, but it can also be applied to the exhaust camshaft 36R.

In addition, in the foregoing example embodiment, the cylinder heads 3L and 3R have a split structure and the camshafts 35L, 35R, 36L, and 36R are placed on the camshaft housings 38L and 38R. Alternatively, however, the cylinder heads 3L and 3R may not have a split structure and the camshafts 35L, 35R, 36L, and 36R may be placed on the cylinder heads 3L and 3R.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1-6. (canceled)

7. An assembled camshaft in which a fuel pump driving cam is assembled onto a camshaft main body that is provided with a plurality of valve operating cams, wherein:
the fuel pump driving cam is assembled onto the camshaft main body by press-fitting in a position between the outer most valve operating cams in an axial direction of the camshaft main body, from among the plurality of valve operating cams that are arranged along the camshaft main body in the axial direction;
at least one of the outer most valve operating cams is assembled to the camshaft main body by press-fitting;
a plurality of valve operating cam press-fitting portions and a single fuel pump driving cam press-fitting portion are formed on the camshaft main body; and
an outer diameter dimension of the fuel pump driving cam press-fitting portion is larger than the outer diameter dimensions of the valve operating cam press-fitting portions.

8. The assembled camshaft according to claim 7, wherein the outer diameter dimensions of the valve operating cam press-fitting portions are set such that the closer the valve operating cam press-fitting portion is to the fuel pump driving cam press-fitting portion, the larger the outer diameter dimension of that valve operating cam press-fitting portion is.

9. The assembled camshaft according to claim 7, wherein the valve operating cams are formed of solid phase sintered material.

10. The assembled camshaft according to claim 7, wherein the fuel pump driving cam is formed of liquid phase sintered material.

11. An internal combustion engine, comprising:
an assembled camshaft in which a fuel pump driving cam is assembled onto a camshaft main body that is provided with a plurality of valve operating cams, wherein the fuel pump driving cam is assembled onto the camshaft main body by press-fitting in a position between the outer most valve operating cams in an axial direction of the camshaft main body, from among the plurality of valve operating cams that are arranged along the camshaft main body in the axial direction; at least one of the outer most valve operating cams is assembled to the camshaft main body by press-fitting; a plurality of valve operating cam press-fitting portions and a single fuel pump driving cam press-fitting portion are formed on the camshaft main body; and an outer diameter dimension of the fuel pump driving cam press-fitting portion is larger than the outer diameter dimensions of the valve operating cam press-fitting portions;
a cylinder head that rotatably supports the assembled camshaft;
a fuel pump that increases a pressure of fuel to be supplied to a combustion chamber of the internal combustion engine; and
a fuel pump support bracket which is supported by the cylinder head and supports the fuel pump in a position corresponding to the fuel pump driving cam.

12. The internal combustion engine according to claim 11, wherein:
a camshaft housing that rotatably supports the assembled camshaft is provided on the cylinder head;
a first semi-circular recessed portion is formed on the camshaft housing, and that rotatably supports the assembled camshaft; and
a second semi-circular recessed portion is formed on the fuel pump support bracket, and that rotatably supports the assembled camshaft in a position facing the first semi-circular recessed portion.
